(19) United States
(12) Patent Application Publication
(10) Pub. No.: US 2025/0344233 A1
(43) Pub. Date: Nov. 6, 2025

(54) RESOURCE ALLOCATION FOR PROVISIONING SYSTEMS IN WIRELESS COMMUNICATION NETWORKS

(71) Applicant: T-MOBILE INNOVATIONS LLC, Overland Park, KS (US)

(72) Inventors: Henry Pradeep Kumar Cyril, Bothell, WA (US); Shrustishree Sumanth, Bothell, WA (US)

(21) Appl. No.: 18/655,801

(22) Filed: May 6, 2024

(51) Int. Cl. H04W 72/52; H04W 72/543

(52) U.S. Cl. CPC H04W 72/52; H04W 72/543

(57) ABSTRACT

Various embodiments include a wireless communication network that comprises resource allocation circuitry. The resource allocation circuitry hosts a traffic forecasting machine learning model, a resource forecasting machine learning model, and a resource allocation machine learning model. The resource allocation circuitry obtains traffic data for a provisioning engine cluster and provides the traffic data to the traffic forecasting model. The resource allocation circuitry obtains an output that comprises a traffic prediction for the provisioning engine cluster and provides the prediction to the resource forecasting model. The resource allocation circuitry obtains an output that comprises a hardware requirement prediction for the provisioning engine cluster and provides the hardware requirement prediction to the resource allocation model. The resource allocation circuitry obtains an output that comprises a hardware allocation recommendation for the network provisioning engine cluster. The resource allocation circuitry allocates hardware resources to the cluster based on the hardware allocation recommendation.

### TECHNICAL FIELD

Various embodiments of the present technology relate to provisioning, and more specifically, to allocating computing resources to network provisioning systems.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices. Exemplary network functions include Access and Mobility Management Function (AMF), Policy Control Function (PCF), Unified Data Management (UDM), and Unified Data Registry (UDR).

Service provisioning relates to enabling customer services in a wireless communication network. The network provisioning engine is a network entity responsible for service provisioning. The provisioning engine receives a subscription request for a user device from a billing system. The subscription request comprises service descriptors that characterize the user device's subscription on the wireless network. For example, the service descriptors may indicate the user device is subscribed for domestic voice calling and domestic data service. The provisioning engine converts the service descriptors into network attributes interpretable by the network functions in the core network. The provisioning engine loads the attributes onto the network functions to enable service for the user device.

A given wireless communication network typically operates multiple network provisioning engines that are associated with different subscriber types on the network. For example, a first provisioning engine may provision services for prepaid network subscribers while a second provisioning engine may provision services for Mobile Virtual Network Operators (MVNO) subscribers. The provisioning engines execute in a virtualized computing environment that utilizes a shared pool of physical computing resources. Since each provisioning engine is associated with a different subscriber type, the traffic patterns and traffic volumes vary between the provisioning engines. Given the large number of provisioning engines and correspondingly large number of dynamic traffic patterns, it is difficult to allocate hardware resources from the shared pool of physical computing resources to meet the computing needs of each provisioning engine in the network. When a provisioning engine experiences an uptick in traffic but is not allocated sufficient computing resources, the provisioning engine may be unable to provision network attributes to the network functions which degrades the user experience.

Unfortunately, in some instances, wireless communication networks may not efficiently allocate computing resources to network provisioning engines. Moreover, some wireless communication networks may not always effectively anticipate the computing needs of the network provisioning engines.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless network provisioning. Some embodiments comprise a method. The method comprises hosting, by a resource allocation system in a wireless communication network, a traffic forecasting machine learning model, a resource forecasting machine learning model, and a resource allocation machine learning model. The method further comprises obtaining traffic data from a network provisioning engine cluster, wherein the traffic data characterizes a provisioning request rate in the network provisioning engine cluster. The method further comprises providing the traffic data to the traffic forecasting machine learning model and obtaining a first machine learning output that comprises a future traffic prediction for the network provisioning engine cluster. The method further comprises providing the future traffic prediction to the resource forecasting machine learning model and obtaining a second machine learning output that comprises a future hardware requirement prediction for network provisioning engine cluster. The method further comprises providing the future hardware requirement prediction to the resource allocation machine learning model and obtaining a third machine learning output that comprises a hardware allocation recommendation for the network provisioning engine cluster. The method further comprises allocating hardware resources to the network provisioning engine cluster based on the hardware allocation recommendation.

Some embodiments comprise a wireless communication network. The wireless communication network comprises network provisioning circuitry and resource allocation circuitry. The network provisioning circuitry hosts a network provisioning engine cluster and transfers traffic data that characterizes a provisioning request rate in the network provisioning engine cluster. The resource allocation circuitry hosts a traffic forecasting machine learning model trained, a resource forecasting machine learning model, and a resource allocation machine learning model. The resource allocation circuitry obtains the traffic data. The resource allocation circuitry provides the traffic data to the traffic forecasting machine learning model and obtains a first machine learning output that comprises a future traffic prediction for the network provisioning engine cluster. The resource allocation circuitry provides the future traffic prediction to the resource forecasting machine learning model and obtains a second machine learning output that comprises a future hardware requirement prediction for the network provisioning engine cluster. The resource allocation circuitry provides the future hardware requirement prediction to the resource allocation machine learning model and obtains a third machine learning output that comprises a hardware allocation recommendation for the network provisioning engine cluster. The resource allocation circuitry directs the network provisioning circuitry to allocate hardware resources to the network provisioning engine cluster based on the hardware allocation recommendation.

Some embodiments comprise one or more non-transitory computer-readable storage media having program instructions stored thereon. When executed by a computing system, the program instructions direct the computing system to perform operations. The operations comprise hosting a traffic forecasting machine learning model trained, a resource forecasting machine learning model, and a resource allocation machine learning model trained. The operations further comprise obtaining traffic data from a network provisioning engine cluster, wherein the traffic data characterizes a provisioning request rate in the network provisioning engine cluster. The operations further comprise providing the traffic data to the traffic forecasting machine learning model and obtaining a first machine learning output that comprises a future traffic prediction for the network provisioning engine cluster. The operations further comprise providing the future traffic prediction to the resource forecasting machine learning model and obtaining a second machine learning output that comprises a future hardware requirement prediction for network provisioning engine cluster. The operations further comprise providing the future hardware requirement prediction to the resource allocation machine learning model and obtaining a third machine learning output that comprises a hardware allocation recommendation for the network provisioning engine cluster. The operations further comprise allocating hardware resources to the network provisioning engine cluster based on the hardware allocation recommendation.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates a wireless communication network.

FIG. 4 illustrates an exemplary operation of the wireless communication network.

FIG. 5 illustrates an exemplary operation of the wireless communication network.

FIG. 6 illustrates a Fifth Generation (5G) wireless communication network.

FIG. 7 illustrates network functions and a provisioning system in the 5G wireless communication network.

FIG. 8 illustrates an exemplary operation of the 5G wireless communication network.

FIG. 9 illustrates an exemplary operation of the 5G wireless communication network.

FIG. 10 illustrates an exemplary operation of the 5G wireless communication network.

FIG. 11 illustrates an exemplary operation of the 5G wireless communication network.

FIG. 12 illustrates a Network Function Virtualization Infrastructure (NFVI) and provisioning system in the 5G wireless communication network.

FIG. 13 further illustrates the NFVI and provisioning system in the 5G wireless communication network.

FIG. 14 illustrates an exemplary operation of the 5G wireless communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

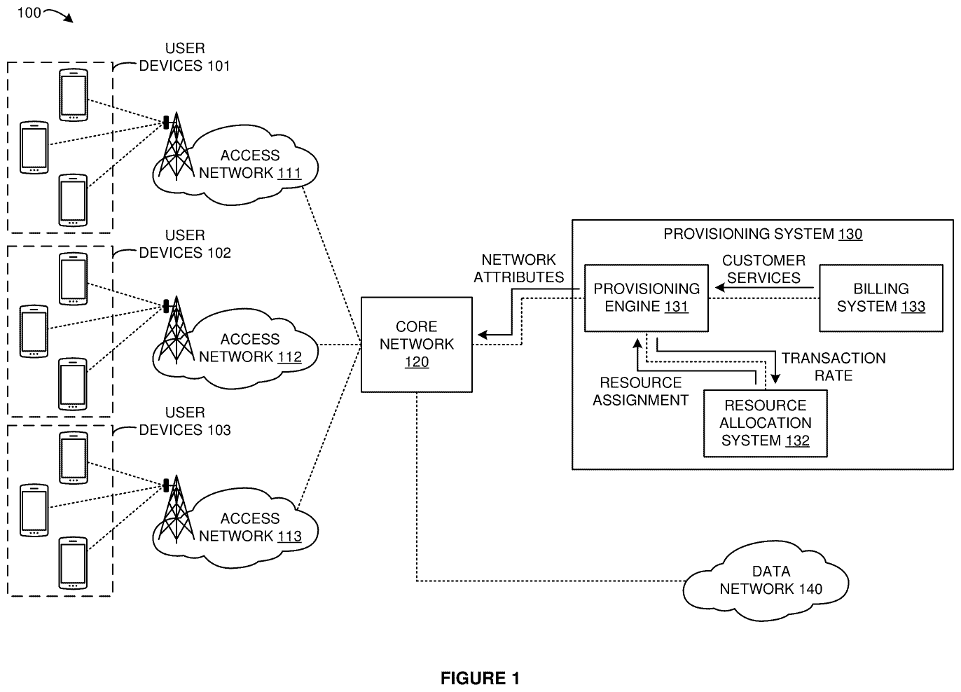

FIG. 1 illustrates communication network 100 to allocate resources for network provisioning systems. Communication network 100 delivers services like voice calling, machine communications, internet-access, media-streaming, or some other wireless/wireline communications product to user devices. Communication network 100 comprises user devices 101-103, access networks 111-113, core network 120, provisioning system 130, and data network 140. Provisioning system 130 comprises provisioning engine 131, resource allocation system 132, and billing system 133. In other examples, communication network 100 may comprise additional or different elements than those illustrated in FIG. 1.

Various examples of network operation and configuration are described herein. In some examples, core network 120 provides wireless services to user devices 101-103 over access networks 111-113. Core network 120 serves devices 101 over access network 111, devices 102 over access network 112, and devices 103 over access network 113. Billing system 133 receives a service update for a user device (e.g., one of the devices in user device 102). Exemplary services include voice calling, international voice, domestic/international roaming, call forwarding, call waiting capability, Short-Message-Service (SMS), Multimedia Messaging Service (MMS), Rich Communication Service (RCS), domestic data service, data hotspot, roaming data service, voicemail, static Internet Protocol (IP) address management, Wi-Fi calling, scam protection, value added services, and the like. Service updates are customer requests to activate services, add services, deactivate services, and the like. Service requests may also be network triggered (e.g., service shutoff in response to billing delinquency). Billing system 133 transfers the requested customer services to provisioning engine 131.

Provisioning engine 131 is a network entity responsible for translating customer services into network service attributes and providing the network service attributes to core network 120 to enable the services to the user device. Provisioning engine 131 translates the customer services into network attributes interpretable by network elements in core 120. Provisioning engine 131 transfers the resulting network attributes to core network 120. For example, provisioning engine 131 may receive a customer service code selecting domestic voice calling (e.g., VOICE_MO_NAT). Provisioning engine 131 may then translate the customer service code into key value pairs interpretable by network elements in core 120 to enable domestic voice calling for the user device over access networks 111-113. Core network 120 comprises network functions, network entities, network data systems, subscriber profiles, and/or other network systems responsible for serving user devices 101-103. Core network 120 receives the service attributes from provisioning engine 131. The network elements in core network 120 update existing service attributes using the received service attributes to update service to the associated user device.

As provisioning engine 131 operates to enable service to user device 101-103 on core network 120, provisioning engine 131 generates data characterizing the transaction rate of its computing systems. Provisioning engine 131 reports its transaction rate to resource allocation system 132. For example, provisioning engine 131 may report its average Transaction Per Second (TPS) rate over a time period (e.g., 15 minutes). Resource allocation system 132 estimates the future transaction rate for provisioning system based on the current transaction rate and the current time. For example, resource allocation system 132 may host a machine learning model trained to predict the transaction rate of provisioning engine 131 based on current transaction rates and times of day. Resource allocation system 132 estimates the computing resources needed by provisioning engine 131 to support the estimated transaction rate. Exemplary computing resources include microprocessor amounts, memory amounts, and the like. Allocation system 132 may estimate the needed computing resources in multiple ways. In some examples, resource allocation system 132 hosts a data structure (e.g., a lookup table) that correlates transaction rates to required hardware resources. In some examples, resource allocation system 132 hosts an algorithm that receives estimated transaction rates as input and provides an output that indicates the hardware resources needed to support the data rate. In some examples, resource allocation system 132 hosts a machine learning model trained to predict hardware resource needs based on estimated transaction rate. Once the computing resources are estimated, resource allocation system 132 allocates computing resources to network provisioning engine 131 based on the estimate.

User devices 101-103 are representative of wireless/wireline user devices. Exemplary device types include phones, smartphones, computers, vehicles, drones, robots, sensors, controllers, and/or other devices with wireless communication capabilities. Access networks 111-113 exchange wireless signals with user devices 101-103 over radio frequency bands. The radio frequency bands use wireless network protocols like Sixth Generation (6G), Fifth Generation New Radio (5GNR), Long Term Evolution (LTE), Institute of Electrical and Electronic Engineers (IEEE) 802.11 (WIFI), and Low-Power Wide Area Network (LP-WAN). Access networks 111-113 are connected to core network 120 over backhaul data links. Access networks 111-113 exchange network signaling and user data with core network 120.

Access networks 111-113 may comprise wireless access nodes, internet backbone providers, edge computing systems, or other types of wireless/wireline access systems to provide communication links to user devices 101-103, the backhaul links to core network 120, and the edge computing services between user devices 101-103 and core network 120. Although access networks 111-113 are illustrated comprising towers, access networks 111-113 may comprise other types of mounting structures (e.g., buildings), or no mounting structure at all. Access networks 111-113 may comprise 6G RANs, Fifth Generation (5G) RANs, LTE RANs, gNodeBs, eNodeBs, NB-IoT access nodes, LP-WAN base stations, wireless relays, WIFI hotspots, Bluetooth access nodes, and/or other types of wireless or wireline network transceivers. Access networks 111-113 may comprise a Radio Unit (RU), Distributed Unit (DU), and Centralized Unit (CU) architecture. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 120. The CUS handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user devices 101-103 over access networks 111-113. Exemplary computing systems comprise data centers, server farms, Network Function Virtualization Infrastructure (NFVI), cloud computing networks, hybrid cloud networks, and the like. The computing systems of core network 120 store and execute the network functions to provide wireless data services to user devices 101-103 over access networks 111-113 and provide communications with data network 140. The network functions typically form a control plane to support control signaling and a user plane to support user date exchange. The control plane typically comprises network functions like Access and Mobility Management Function (AMF), Session Management Function (SMF), and the like. The user plane typically comprises network functions like User Plane Function (UPF) and the like. Other network functions/entities that may be present in core network 120 include Unified Data Management (UDM), Policy Control Function (PCF), Short Message Service Function (SMFS), Charging Function (CHF), Unified Data Registry (UDR), Home Subscriber Server (HSS), Home Subscriber Register (HLR), and the like. Core network 120 may comprise a Sixth Generation Core (6GC) architecture, Fifth Generation Core (5GC) architecture, an Evolved Packet Core (EPC) architecture, and the like. Data network 140 is representative of a communication endpoint for user devices 101-103. Data network 140 may comprise another communication network, a content provider, a streaming service, an Application Server (AS), and the like.

Provisioning system 130 is representative of computing systems that enable subscribed services to user devices 101-103 on core network 120. Exemplary computing systems comprise data centers, server farms, provisioning virtualized infrastructures, cloud computing networks, hybrid cloud networks, and the like. Provisioning system 130 may utilize a container-based orchestration system like Kubernetes. The computing systems of core network 120 store and execute provisioning functions to enable subscribed services of user devices 101-103. Provisioning engine 131 comprises provisioning functions like network provisioning engines clusters, provisioning catalogs, and the like. Resource allocation system 132 comprises provisioning functions like traffic prediction models, resource prediction models, resource allocation models, and the like. Billing system 133 comprises provisioning entities like Customer Relations Management (CRM) server, and the like.

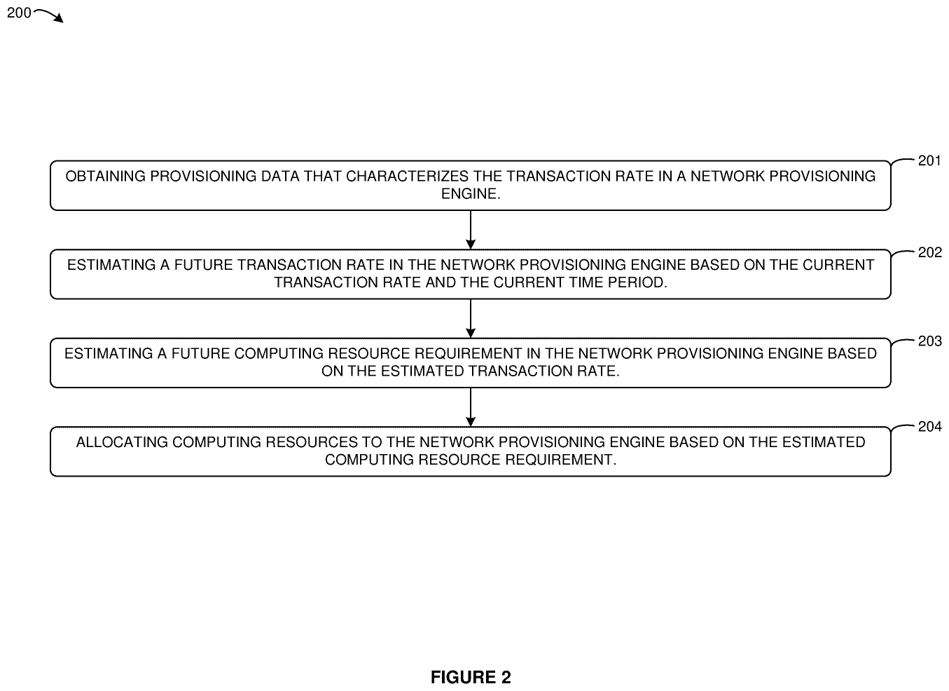

FIG. 2 illustrates process 200. Process 200 comprises an exemplary operation of communication network 100 to allocate resources for network provisioning systems. The operation may vary in other examples. The operations of process 200 comprise obtaining provisioning data that characterizes the transaction rate in a network provisioning engine (step 201). The operations further comprise estimating a future transaction rate in the network provisioning engine based on the current transaction rate and the current time period (step 202). The operations further comprise estimating a future computing resource requirement in the network provisioning engine based on the estimated transaction rate (step 203). The operations further comprise allocating computing resources to the network provisioning engine based on the estimated computing resource requirement (step 204).

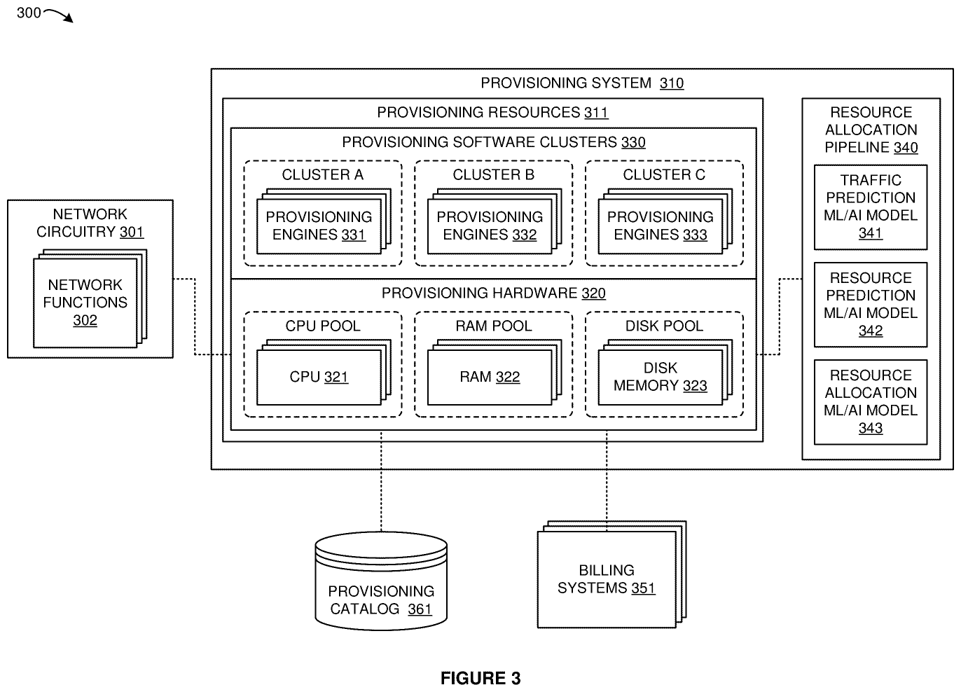

FIG. 3 illustrates wireless communication network 300 to allocate resources for network provisioning systems. Wireless communication network 300 is an example of communication network 100, however network 100 may differ. Wireless communication network 300 comprises network circuitry 301, provisioning system 310, billing systems 351, and provisioning catalog 361. Network circuitry 301 comprises network functions 302. Network functions 302 comprise 6GC, 5GC, and/or EPC network entities like AMF, SMF, UPF, PCF, UDM, SMSF, HSS, HLR, Session Communication Proxy (SCP), and Diameter Routing Agent (DRA). Provisioning system 310 comprises provisioning resources 311 and resource allocation pipeline 340. Provisioning resources 311 comprises provisioning hardware 320 and provisioning software clusters 330. Provisioning hardware 320 comprises Central Processing Unit (CPU) 321, Random Access Memory (RAM) 322, and disk memory 323 organized into a CPU pool, RAM pool, and disk memory pool. Provisioning software clusters 330 comprises provisioning engines 331-333 organized into clusters A, B, and C. Resource allocation pipeline 340 comprises traffic prediction machine learning (ML)/artificial intelligence (AI) model 341, resource prediction machine learning (ML)/artificial intelligence (AI) model 342, and resource allocation machine learning (ML)/artificial intelligence (AI) model 343. In other examples, wireless network 300 may comprise additional or different elements than those illustrated in FIG. 3.

In some examples, provisioning resources 311 allocates an initial amount of CPU 321, RAM 322, and disk memory 323 to clusters A, B, and C. For example, resources 311 may allocate 50% of available CPU, RAM, and Disk memory to cluster A and 20% to cluster B, 20% to cluster C, and leave 10% as a reserve. Although expressed as percentages in the above example, CPU 321, RAM 322, and disk memory 323 may be allocated in absolute numbers (e.g., 35 CPUs to cluster A). The allocated portions of CPU 321 retrieve and execute software stored on corresponding portions of disk memory 323 to form provisioning engines 331-333. It should be appreciated that provisioning engines 331-333 utilize a common pool of hardware resources and the amount of hardware resources allocated to a given cluster may vary.

Provisioning resources 311 receives a subscriber profile update from billing systems 351. For example, a user in network 300 may have upgraded their level of service (e.g., added international voice calling) and the one of billing systems 351 associated with the user may transfer the update to resources 311 to modify the user's subscriber profile to include the upgraded service level. Resources 311 routes the request to one of clusters A, B, and C that corresponds to the one of billings systems 351 that sent the resource. For example, the sending billing system may comprise a prepaid service billing system and cluster A may comprise provisioning engines for prepaid service provisioning.

The provisioning engines that received the request identify the subscriber profile associated with the update based on a subscriber Identifier (ID) like International Mobile Subscriber Identity (IMSI), Subscriber Permanent Identifier (SUPI), and the like. The provisioning engines access provisioning catalog 361 to translate customer facing service codes received in the request into network facing service attributes interpretable by network functions 302. Provisioning resources 311 transfers a provisioning command to network functions 302 to modify the subscriber profiles using the translated network service attributes. Network functions 302 locate corresponding subscriber profile based on the subscriber ID and implement the provisioning update.

Provisioning engines 331-333 generate traffic data that characterizes the transaction rate in provisioning hardware 320. The traffic data may indicate the number of requests received from billing systems 351, traffic distribution between clusters A-C, the number of successful requests, the number of request failures, TPS rate per cluster, total TPS rate, and the like. TPS rate measures the rate of transactions executed by CPU 321 executing provision engines 331-333. It should be appreciated that TPS rates correlate with the amount of traffic handled by a cluster. As the amount of traffic handled by a cluster increases, the TPS rate also increases for that cluster. Likewise, as the traffic handled by a cluster decreases, the TPS rate also decreases for that cluster. Provisioning engines 331-333 transfer the traffic data to resource allocation pipeline 340. Resource allocation pipeline 340 provides the traffic data to traffic prediction model 341. Model 341 is representative of a machine learning model trained to predict future traffic conditions (e.g., future TPS rate) in provisioning resources 311 based on current traffic conditions, the time of day, day of week, the date, and/or other metrics. Model 341 ingests the traffic data and generates a machine learning output that predicts upcoming traffic conditions for engines 331-333. For example, the output may predict the TPS rate for provisioning engines 331 15 minutes in the future.

Resource allocation pipeline 340 provides the traffic prediction generated by model 341 to resource prediction model 342. Model 342 is representative of a machine learning model trained to predict hardware requirements (e.g., CPU percent, RAM percent, and disk memory percent) in provisioning resources 311 based on predicted traffic and/or other metrics. Model 342 ingests the traffic prediction and generates a machine learning output that predicts required hardware resources. For example, the output may recommend allocating 40% of the CPUs 321, RAM 322, and disk memory 323 to cluster A to support a predicted TPS rate of 500. Resource allocation pipeline 340 provides the hardware requirement prediction to resource allocation model 343. Model 343 is representative of a machine learning model trained to allocate hardware resources to provisioning engine clusters based on CPU capacity, RAM capacity, disk memory capacity, predicted hardware requirements, predicted TPS rates, a minimum hardware utilization threshold, a maximum hardware utilization threshold, and/or other metrics. Model 343 ingests the hardware requirement prediction and generates a machine learning output that allocates hardware resources to clusters A, B, and C. For example, the output may allocate 35% of the CPUs, RAM, and disk memory to cluster A.

Resource allocation pipeline 340 transfers a hardware allocation command that comprises the allocations recommended by model 343 to provisioning resources 311. Provisioning resources 311 adjusts the percentage of CPUs 321, RAM 322, and disk memory 323 allocated to clusters A, B, and C based on the hardware allocation command. For example, the hardware allocation command may assign 60% of the hardware resources to cluster A, 15% of the hardware resources to clusters B and C, and leave 10% of the hardware resources as a resource. In response, resources 311 may increase the hardware allocation for cluster A from the initial allocation of 50% to 60%, reduce the hardware allocations to clusters B and C from the initial allocations of 20% to 15%, and leave 10% of CPUs 321, RAM 322, and disk memory 323 as a reserve.

Advantageously, wireless communication network 300 efficiently allocates computing resources to network provisioning engines 331-333. Moreover, wireless communication network 300 effectively predicts future traffic conditions and future hardware requirements for network provisioning engines 331-333.

Network circuitry 301, provisioning system 310, billing systems 351, and provisioning catalog 361 communicate over various links that use metallic links, glass fibers, radio channels, or some other communication media. The links use Fifth Generation Core (5GC), Evolved Packet Core (EPC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols. Network circuitry 301, provisioning system 310, billing systems 351, and provisioning catalog 361 comprise microprocessors, software, memories, transceivers, bus circuitry, and the like. The microprocessors comprise Digital Signal Processors (DSP), CPU, Graphical Processing Units (GPU), Application-Specific Integrated Circuits (ASIC), Field Programmable Gate Array (FPGA), and/or the like. The memories comprise RAM, flash circuitry, Solid State Drives (SSD), Non-Volatile Memory Express (NVMe) SSDs, Hard Disk Drives (HDDs), and/or the like. The memories store software like operating systems, user applications, network functions, provisioning functions, and multimedia functions. The microprocessors retrieve the software from the memories and execute the software to drive the operation of wireless communication network 300 as described herein.

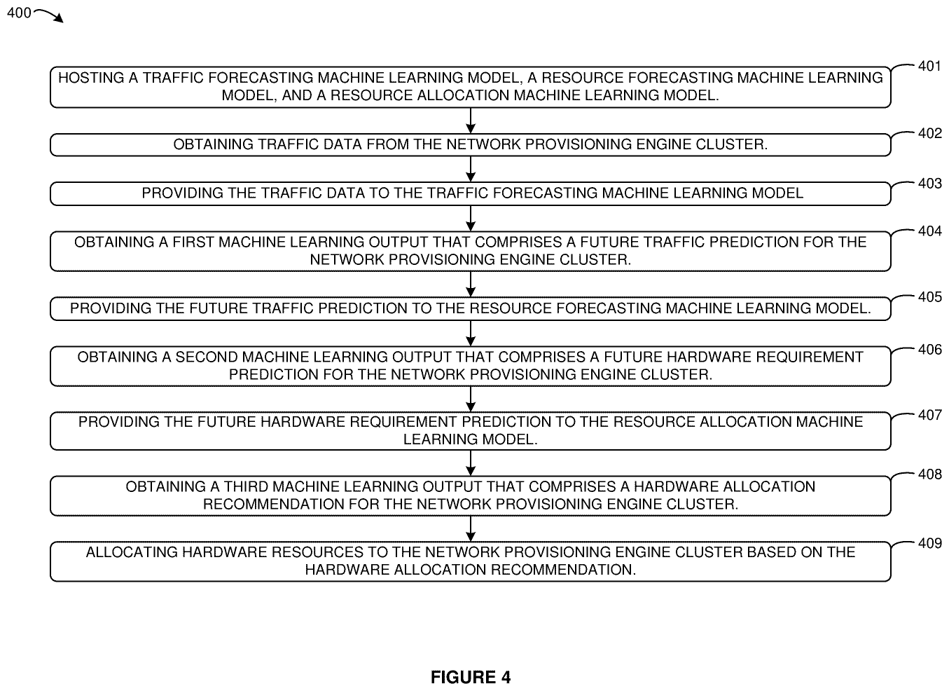

FIG. 4 illustrates process 400. Process 400 comprises an exemplary operation of wireless communication network 300 to allocate resources for network provisioning systems. Process 400 comprises an example of process 200 illustrated in FIG. 2, however process 200 may differ. The operations of process 400 comprise hosting a traffic forecasting machine learning model, a resource forecasting machine learning model, and a resource allocation machine learning model (step 401). The traffic forecasting machine learning model is trained to predict future traffic conditions in a network provisioning engine cluster. The resource forecasting machine learning model is trained to predict future hardware requirements in the network provisioning engine cluster. The resource allocation machine learning model is trained to allocate hardware resources to the network provisioning engine cluster. The operations further comprise obtaining traffic data from the network provisioning engine cluster (step 402). The traffic data characterizes a provisioning request rate in the network provisioning engine cluster. The operations further comprise providing the traffic data to the traffic forecasting machine learning model (step 403). The operations further comprise obtaining a first machine learning output that comprises a future traffic prediction for the network provisioning engine cluster (step 404). The operations further comprise providing the future traffic prediction to the resource forecasting machine learning model (step 405). The operations further comprise obtaining a second machine learning output that comprises a future hardware requirement prediction for network provisioning engine cluster (step 406). The operations further comprise providing the future hardware requirement prediction to the resource allocation machine learning model (step 407). The operations further comprise obtaining a third machine learning output that comprises a hardware allocation recommendation for the network provisioning engine cluster (step 408). The operations further comprise allocating hardware resources to the network provisioning engine cluster based on the hardware allocation recommendation (step 409).

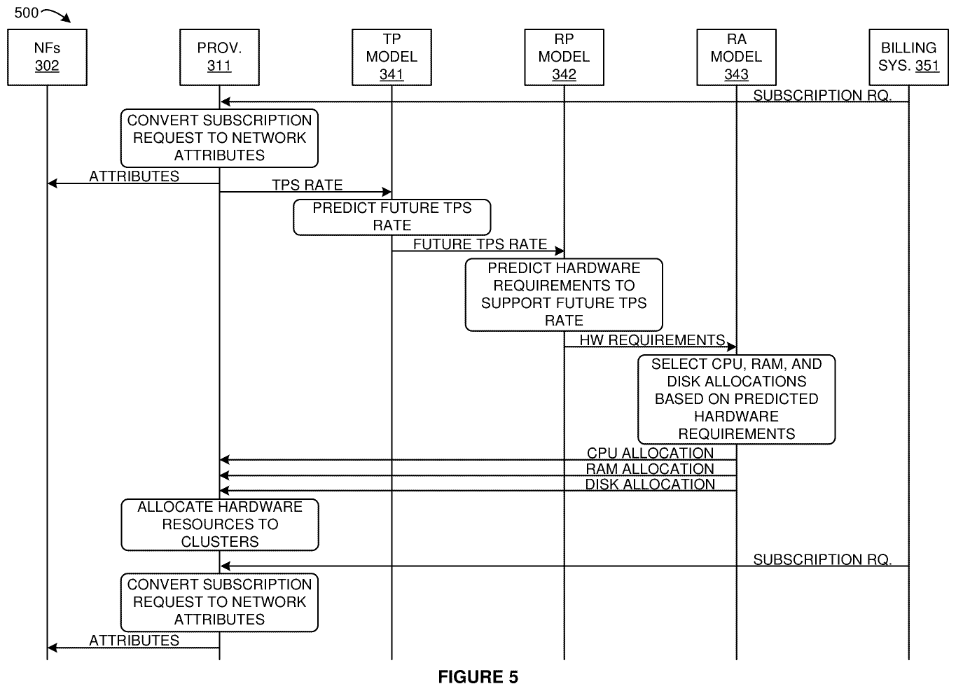

FIG. 5 illustrates process 500. Process 500 comprises an exemplary operation of wireless communication network 300 to allocate resources for network provisioning systems. Process 500 comprises an example of process 200 illustrated in FIG. 2 and process 400 illustrated in FIG. 4, however processes 200 and 400 may differ. In some examples, billing systems (SYS.) 351 receive customer requests to update their subscription on network 300. For example, a customer request may comprise a device activation, device deactivation, service addition, service removal, service restoration, and the like. Billing systems 351 transfer subscription requests (RQ.) comprising customer facing attributes that characterize the service requests to provisioning resources (PROV.) 311.

Provisioning engines 331-333 receive the requests from corresponding ones of billing system 351. Provision engines 331-333 interface with catalog 361 to translate the customer facing attributes into network facing attributes to enable the subscription changes for the customers. Once the customer facing attributes have been translated, provisioning engines 331-333 generate provisioning commands comprising the translated attributes and transfer the commands to one or more of network functions (NFs) 302. Network functions 302 load the attributes to corresponding subscriber profile to implement the customer request. For example, a provisioning command may include an address value pair (e.g., an attribute) to modify authorized QoS for a subscriber and one of network functions 302 may update the existing authorized QoS address value pair with the address value pair included in the provisioning command.

As provisioning engines 331-333 receive subscription requests from billing systems 351, translate the customer facing attributes into network facing attributes, and load the network facing attributes to network functions 302, provisioning engines 331-333 track the TPS rate in hardware 320. For example, engines 331-333 may track the TPS rate of their allocated portion of CPUs 321. Provisioning engines 331-333 indicate their TPS rates to resource allocation pipeline 340. Engines 331-333 may report their TPS rates continuously or in batches. For example, engines 331-333 may transfer batch files that indicate the average TPS rates in 15-minute (or some other time scale) increments.

Resource allocation pipeline 340 converts the received TPS rates into feature vectors and provides the resulting feature vectors to traffic prediction model (TP) 341. A feature vector is a numeric representation of data interpretable by a machine learning model. For example, one of the feature vectors may comprise a numeric representation of the average TPS rate for cluster A over a given time period. Traffic prediction model 341 ingests the feature vectors representing TPS rates for clusters A, B, and C and generates a machine learning output. The machine learning output comprises predicted TPS rates for clusters A, B, and C. Pipeline 340 converts the predicted TPS rates into feature vectors and provides the resulting vectors to resource prediction (RP) model 342. Resource prediction model 342 ingests the feature vectors representing the predicted TPS rates for clusters A, B, and C and generates a machine learning output. The machine learning output comprises predicted CPU, RAM, and disk memory requirements for clusters A, B, and C to support the predicted TPS rates for clusters A, B, and C. Pipeline 340 converts the predicted CPU, RAM, and disk memory requirements into feature vectors and provides the resulting vectors to resource allocation (RA) model 343. Resource allocation model 343 ingests the feature vectors representing predicted CPU, RAM, and disk memory requirements for clusters A, B, and C and generates a machine learning output. The machine learning output recommends CPU, RAM, and disk memory allocations for clusters A, B, and C. Resource allocation pipeline 340 transfers the CPU allocation, RAM allocation, and disk memory allocation for clusters A, B, and C to provisioning resources 311. A resource management entity in resources 311 allocates the recommended portions of CPUs 321, RAM 322, and disk memory 323 to clusters A, B, and C.

Billing systems 351 receives subsequent customer requests to update their subscriptions on network 300. Billing systems 351 transfer subsequent subscription requests that comprise customer facing attributes to provisioning resources 311. Provisioning resources 311 executes engines 331-333 using the new allocations of CPU 321, RAM 322, and disk memory 323. Utilizing their new hardware allocations, provisioning engines 331-333 interface with catalog 361 to translate the customer facing attributes into network facing attributes. Provisioning engines 331-333 generate provisioning commands comprising the translated attributes and transfer the commands to network functions 302. Network functions 302 load the subscriber profiles with the received attributes.

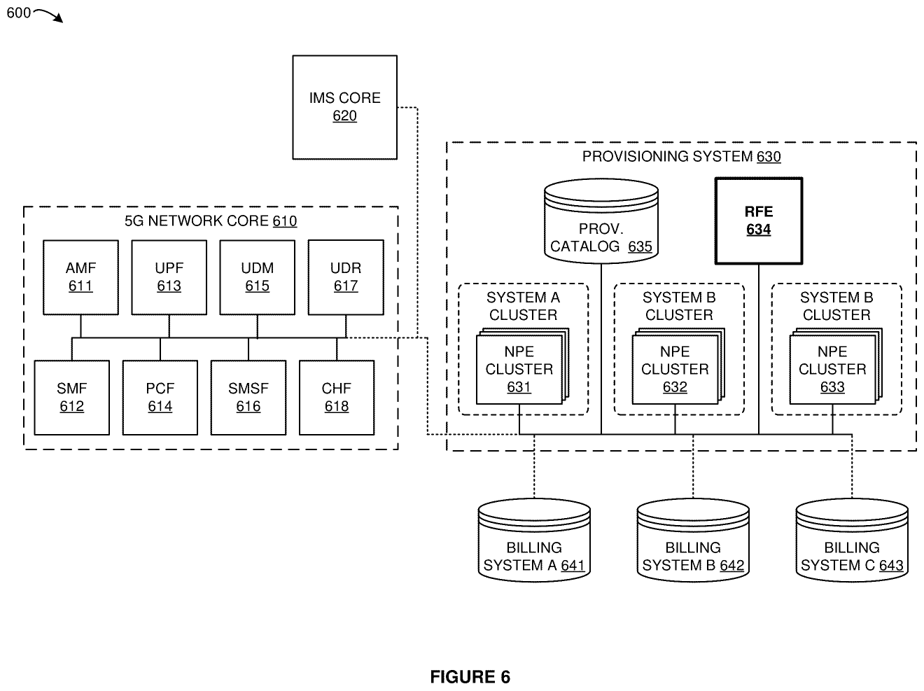

FIG. 6 illustrates 5G communication network 600 to allocate resources for network provisioning systems. 5G communication network 600 comprises an example of communication network 100 illustrated in FIG. 1 and wireless communication network 300 illustrated in FIG. 3, however networks 100 and 300 may differ. 5G communication network 600 comprises 5G network core 610, Internet Protocol Multimedia (IMS) core 620, provisioning system 630, and billing systems 641-643. Network core 610 comprises AMF 611, SMF 612, UPF 613, PCF 614, UDM 615, SMSF 616, UDR 617, and CHF 618. Other network functions and network entities like Authentication Server Function (AUSF), Network Slice Selection Function (NSSF), Network Repository Function (NRF), Equipment Identity Register (EIR), Network Exposure Function (NEF), and Application Function (AF) are typically present in 5G network core 610, IMS core 620, and/or provisioning system 630 but are omitted for clarity. Provisioning system 630 comprises Network Provisioning Engine (NPE) clusters 631-633, Resource Forecasting Engine (RFE) 634, and provisioning (PROV.) catalog 635. As illustrated in FIG. 6, billing systems 641-643 are labeled A, B, and C, respectively. Each billing system is associated with an operator or subscription type on network 600. For example, billing systems 641-643 may be associated with the primary operator of network 600, Mobile Virtual Network Operators (MVNOs) operating on network 600, prepaid subscribers, postpaid subscribers, wholesale subscribers, and the like. Each of NPE clusters 631-633 correspond to one of billing systems 641-643. As illustrated in FIG. 6, NPE cluster 631 corresponds to billing system A 641, NPE cluster 632 corresponds to billing system B 642, and NPE cluster 633 corresponds to billing system C 643. In other examples, 5G communication network 600 may comprise different or additional elements than those illustrated in FIG. 6.

In some examples, NPE clusters 631-633 execute on a shared virtualized provisioning infrastructure. The virtualized infrastructure utilizes a common pool of computing resources like CPU, GPU, RAM, disk memory, interface cards, and the like to form clusters 631-633. It should be appreciated that at any given point in time, there exists a limited pool of computing resources available for each of clusters 631-633. The portion of computing resources allocated to any given cluster may vary with time. For example, cluster 631 may be assigned 30% of the total CPUs at a first time period and 50% of the total available CPU at a second time period.

Billings systems 641-643 detect subscription modification events for subscribers in network 600. The event detections may be automated (e.g., service shutoff in response to unpaid bill) or in response to a customer request (e.g., customer requested service modification and/or service addition). Billing systems 641-643 transfer subscription modification requests to provisioning system 630 based on the billing events. The subscription modification requests identify the brand (e.g., primary operator, MVNO, etc.) and/or subscription type (e.g., prepaid, postpaid, wholesale, etc.) for the sending billing system. The modification requests include codes that indicate the subscription modification type (referred to as the transaction) and the customer services (referred to as Customer Facing Specification (CFS)) that are to be modified. The requests also include a subscriber identity code like IMSI or SUPI. Exemplary transaction types include activation, deactivation, port-in, port-out, update customer profile, update feature, suspension, restore, change MSISDN, change SIM, change bill cycle, BAN to BAN change, add/deduct balance, voicemail PIN reset, line re-provisioning, and the like. Exemplary CFSs include voice, international voice, international/domestic roaming, call forwarding, call waiting capability, SMS, MMS, RCS, domestic data service, hotspot capability, roaming data service, voicemail, static IP management, WiFi calling, fraud protection, value added service, and the like. For example, billing system A 641 may transfer a subscription modification request that indicates it is a prepaid service billing system, includes a code for an activation transaction, includes a CFS for hotspot capability, and identifies a subscriber by IMSI.

Provisioning system 630 receives the modification requests from billing systems 641-643 and routes the requests to corresponding ones of NPE clusters 631-633. For example, provisioning system 630 may route provisioning requests sent by billing system A 641 to NPE cluster 631. NPE clusters 631-633 access provisioning catalog 635 to translate the transaction type and CFS for the brand/service type into a network node types (referred to as Resource Facing Specification (RFS)) and address value pairs (referred to as Logical Resource Specification (LRS)). The RFS defines the network functions/entities in 5G core 610 and/or IMS core 620 where the transaction is to occur. The LRS defines the service attributes in the RFS that are to be updated. For example, NPE cluster 631 may transfer a translation request including an update customer profile transaction and CFS for Quality-of-Service Class Indicator (QCI) increase to catalog 635. In response, catalog 635 may return RFSs for PCF 614 and UDR 617 and LRSs for an increased QCI for the subscriber.

NPE clusters 631-633 generate provisioning updates that include the LRSs retrieved from provisioning catalog 635 and identify the subscribers by IMSI. NPE clusters 631-633 transfer the updates to network functions/entities in cores 610 and 620 based on the RFSs retrieved from catalog 635. For example, if the RFS identifies CHF 618, NPE cluster 631 transfers the update to CHF 618. NPE clusters 631-633 log the updates in a change log maintained by catalog 635. The change log indicates the transaction type, CFS, RFS, LRS, time-stamp, update ID, and/or other data characterizing the provisioning updates. The network functions in cores 610 and 620 receive the provisioning updates and write the LRSs included in the updates to corresponding subscriber profiles stored/managed by the network functions. For example, UDR 617 may store subscriber profiles that include data rate authorizations. UDR 617 may receive a provisioning update that indicates a subscriber profile by IMSI and that includes an LRS for a data rate authorization. UDR 617 may identify the subscriber profile by IMSI and responsively write the received LRS received to the profile to implement the update.

As the updates are loaded to network core 610, AMF 611 receives service requests from User Equipment (UEs) of subscribers associated with the provisioning updates. AMF 611 interfaces with the other network functions in core 610 to authenticate and authorize the UEs for wireless service. In response to authentication and authorization, AMF 611 retrieves service attributes and network policies from the other network functions. The retrieved attributes and network policies include the LRSs provisioned to cores 610 and 620 by provisioning system 630. AMF 611 generates contexts for the UEs based on the retrieved attributes and network policies and directs SMF 612 to establish data sessions for the UEs. SMF 612 controls UPF 613 to serve the UEs over a RAN(s) based on the contexts.

As NPE clusters 631-633 process billing requests received from billing systems 641-643 and provision the network functions in cores 610 and 620 with network attributes to implement the billing request, NPE clusters 631-633 generate data characterizing traffic through provisioning system 630 and computing resource allocations for clusters 631-633. NPE clusters 631-633 track the number of Application Programming Interface (API) requests received from billing systems 641-643, the distribution of requests between clusters 631-633, the percent of requests successfully implemented, the percent of failed requests, the number of requests for core network provisioning, the number of requests for non-core (e.g., IMS, UE, RAN, etc.) provisioning, the number of failed transactions due to capacity/performance limitations, the time to process each request, the total TPS for each of clusters 631-633, and the maximum hardware utilization for each cluster. NPE clusters 631-633 group this data into batch files and provide the batch files to RFE 634. Each batch file corresponds to an operator configured measurement time period and includes the traffic metrics and hardware use statistics collected during that time period. For example, NPE cluster 631 may generate a batch file that includes its CPU, RAM, and disk memory utilization as a percent of its initially allocated CPU, RAM, and disk memory, the number of API requests received from billing systems 641, the proportion of the total number of API requests received by cluster 631, request success/failure rate, proportion of core/non-core requests, the number of capacity/performance-based failures, request process time, and TPS for cluster 631 collected during measurement time period. The batch files may be generated and transferred every minute, five minutes, ten minutes, 15 minutes, or over some other time scale. Once NPE clusters 631-633 transfer their batch files, clusters 631-633 begin collecting traffic metrics for the next measurement time period.

RFE 634 comprises machine learning models trained to allocate computing resources to NPE clusters 631-633. The machine learning models comprise any machine learning model or artificial intelligence system implemented within network 600 trained to predict future transaction rates based on time of day, day of week, and date, predict hardware requirements to support predicted transaction rates, and allocate computing resources to clusters 631-633 based on the predicted hardware requirements. A machine learning model comprises one or more artificial intelligence/machine learning algorithms that are trained based on historical data and/or other types of training data associated with wireless communication networks. A machine learning model may employ one or more machine learning algorithms through which data can be analyzed to identify patterns, make decisions, make predictions, or similarly produce output. Examples of machine learning models that may be employed solely or in conjunction with one another include time-series models, autoregressive models, Holt-winters models, Reimann-Theta Boltzmann models, decomposable time series models, and Neural Prophet models. Other exemplary machine learning models include Large Language Models (LLMs), Three Dimensional (3D) deep leaning models, 3D convolutional neural networks, times series convolutional deep learning, transformers, multi-layer perceptron, long term short memory, and attention based deep learning model, artificial neural networks, nearest neighbor methods, ensemble random forests, support vector machines, naïve Bayes methods, linear regressions, or similar machine learning techniques or combinations thereof capable of predicting output based on input data.

RFE 634 receives the batch files characterizing traffic through provisioning system 630 and hardware use in clusters 631-633. RFE 634 converts the batch files into feature vectors to numerically represent the data. For example, one of the feature vectors may represent the number of transaction failures due to capacity limitations in NPE cluster 631. RFE 634 provides the feature vectors to a traffic forecasting model trained to predict future traffic conditions in clusters 631-633. In particular, the traffic forecasting model is trained to correlate time of day, day of week, and date with the TPS rate of clusters 631-633. The traffic forecasting model processes the feature vectors with its constituent machine learning algorithms to generate a machine learning output. This machine learning output predicts future TPS rates in the hardware executing NPE clusters 631-633. The output may predict the TPS rates in one minute, five minutes, ten minutes, 15 minutes, or some other time in the future.

RFE 634 converts the TPS rate predictions into feature vectors and provides the feature vectors to a resource forecasting model trained to predict computing resources needed to support the predicted TPS rate. In particular, the resource forecasting model is trained to correlate TPS rates to required CPU, RAM, and disk memory amounts. The resource forecasting model processes feature vectors representing the predicted TPS rates with its constituent machine learning algorithms to generate a machine learning output. This machine learning output predicts amounts of CPU, RAM, disk memory, and/or other types of hardware resources needed to support the predicted TPS rates. Higher TPS rates typically require more computing resources than lower TPS rates.

RFE 634 converts the predicted CPU, RAM, and disk memory requirements for clusters 631-633 into feature vectors and provides the feature vectors to a resource allocation model trained to distribute computing resources to clusters 631-633. In particular, the resource allocation model is trained to allocate CPU, RAM, and disk memory from the shared computing resource pool to clusters 631-633 based on hardware requirements, hardware availability, minimum use thresholds, maximum use thresholds, and current TPS rates for the clusters. The resource allocation model processes the feature vectors representing the predicted hardware requirements with its constituent machine learning algorithms to generate a machine learning output to select a CPU allocations, a RAM allocations, and disk memory allocations for the clusters based on the predicted CPU, RAM, and disk memory requirements, current CPU, RAM, and disk memory availabilities, current TPS rate, the minimum hardware utilization threshold, and the maximum hardware utilization. The machine learning output produced by the resource allocation model indicates the selected CPU, RAM, and disk memory allocations for each of clusters 631-633. RFE 634 transfers resource allocation commands to clusters 631-633 indicating the amount of computing resources assigned to each cluster. Clusters 631-633 adjust their respective amounts of CPU, RAM, and disk memory based on the commands.

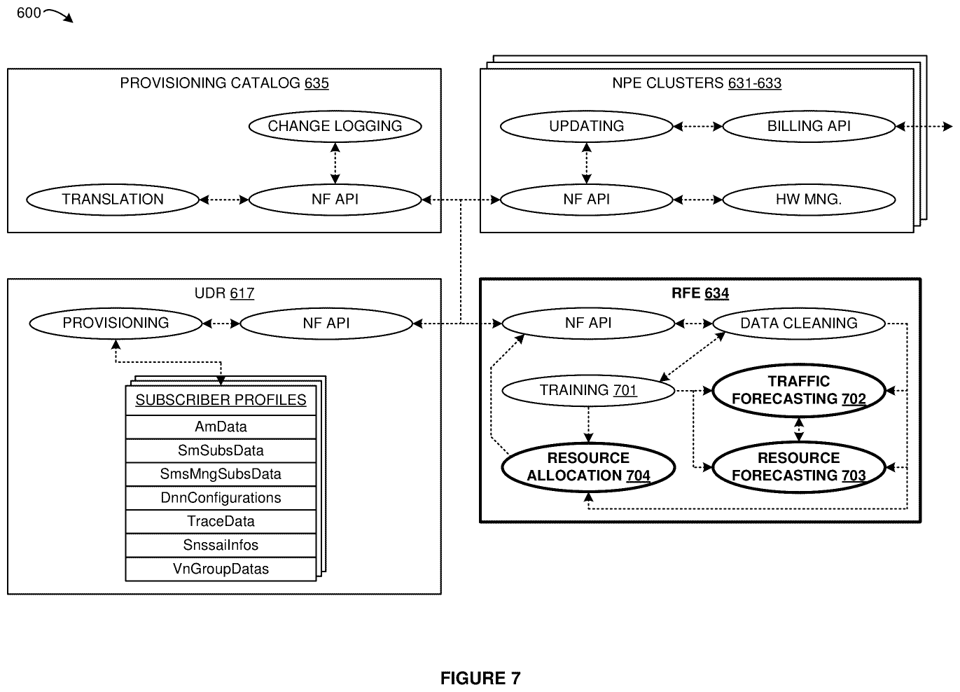

FIG. 7 illustrates UDR 617 and provisioning system 630 in 5G communication network 600. The provisioning relationship between provisioning system 630 and the other network functions in core 610 like PCF 614, UDM 615, SMSF 616, and CHF 618 and with IMS core 620 is similar. UDR 617 comprises modules for provisioning control and network function API and stores subscriber profiles. The provisioning control module implements updates on the subscriber profiles in response to direction from the updating module in NPE clusters 631-633. The subscriber profile comprises service attributes like access and mobility data (AmData), session management subscription data (SmSubsData), SMS management subscription data (SmsMngSubsData), DNN configurations (DnnConfigurations), Trace Data (TraceData), S-NSSAI information (SnssaiInfos), and virtual network group data (VnGroupDatas). Each subscriber profile corresponds to a subscriber ID of a user device like IMSI or SUPI. The service attributes comprise LRS values that define the level of service for user device and often differ from profile to profile. For example, an LRS in a first subscriber profile may enable a first set of DNN configurations while another LRS in a second subscriber profile may enable a different set of DNN configurations. It should be appreciated that the service attributes illustrated in FIG. 7 are exemplary and may differ in other examples.

NPE clusters 631-633 comprise modules for subscription updating, hardware management, network function API, and billing system API. The subscription updating modules process subscription modification requests received from billing systems 641-643 and write provisioning updates to subscriber profiles stored by UDR 617. It should be appreciated that the updating modules may also transfer provisioning updates to the other functions/entities in network 600. The subscription updating module interfaces with RFE 634 to detect provisioning errors and implement machine learning recommendations. The hardware management modules generate traffic metrics and hardware use statistics for the CPUs, RAM, disk memory, transceivers, bus circuitry, and/or other computing resources executing clusters 631-633. The hardware modules generate batch files comprising the collected metrics over a measurement time period and report the batch files to RFE 634 over their respective network functions APIs. The hardware modules allocate hardware resources to clusters 631-633 in response to direction from RFE 634.

RFE 634 comprises modules for network function API, data cleaning, machine learning model training 701, and machine learning models 702-704 for NPE cluster traffic forecasting, NPE cluster resource forecasting, and NPE cluster resource allocation. The data cleaning module filters data received from NPE clusters 631-633 for training module 701 and machine learning models 702-704. Training module 701 trains model 702 based on training data like NPE cluster TPS rates collected in association with times of day, days of week, and dates. Training module 701 trains model 703 based on training data like NPE cluster hardware usage rates (e.g., CPU allocation, RAM allocations, disk memory allocations, etc.) collected in association with NPE cluster TPS rates. Training module 701 trains model 704 based on training data like NPE cluster TPS rates, hardware usage, hardware requirements, and minimum/maximum hardware use threshold. The training processes may be a supervised or unsupervised machine learning process. Model training may continue after the models are pushed to production to continuously advance the model's algorithms and to account for service changes on network 600.

Traffic forecasting model 702 is trained to predict hardware TPS rates in clusters 631-633 based on traffic metrics reported by the hardware management modules in clusters 631-633. Since each of clusters 631-633 are individually associated with billing systems 641-443, model 702 is aware of the rate/amount of API requests received from each of billing systems 641-643 as well as the proportion of these requests that are successfully implemented. Model 702 is also aware of the proportion of TPS transactions associated with each of clusters 631-633.

Resource forecasting model 703 is trained to predict hardware requirements to support predicted TPS rates for each of clusters 631-633 based on the output from traffic forecasting model 702 and current resource use data reported by the hardware management modules in clusters 631-633. Resource forecasting model 703 is provided with CPU, RAM, and disk memory information in the form of the max used during the measurement time period. Model 703 correlates the traffic information for each of clusters 631-633 with the resources utilized by clusters 631-633.

Resource allocation model 704 is trained to allocate hardware resources to clusters 631-633 based on predicted TPS rates for each cluster output by traffic forecasting model 702, predicted hardware requirements for each cluster output by resource forecasting model 703, and current resource use data reported by the hardware management modules in clusters 631-633. Resource allocation model 704 applies maximum/minimum hardware use thresholds to inhibit overallocation/under-allocation of resources to clusters 631-633. When the required hardware resources to support the predicted TPS rates exceed the available resources to support the predicted rates, model 704 allocates resources based on TPS priority to inhibit outages and service interruptions on clusters 631-633. In some examples, model 704 may provide its resource allocation recommendations to an Orchestration and Management (OAM) system which can then be displayed on a user interface for review by network operators.

Provisioning catalog 635 comprises modules for network function API, change logging, and CFS/RFS/LRS translation. The change logging module records provisioning updates implemented by NPE clusters 631-633 with data like CFS, RFS, LRS, time-stamp, update ID, and/or other data characterizing the update. The translation module converts CFSs and transaction types to RFSs and LRSs based on the billing system service type/brand associated with the update. The APIs allow NPE clusters 631-633, RFE 634, catalog 635, and UDR 617 to exchange signaling with each other, the other network functions/entities in 5G core 610 and IMC core 620, and external systems like billing systems 641-643.

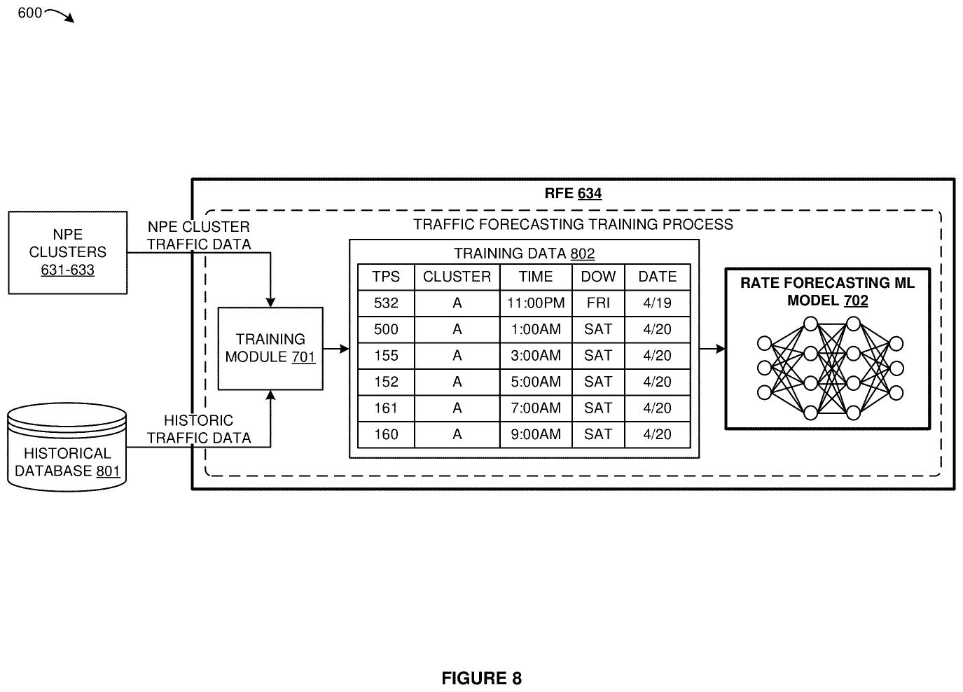

FIG. 8 illustrates an exemplary operation of 5G communication network 600 to train traffic forecasting machine learning (ML) model 702. In some examples, training module 701 collects historic traffic data for NPE clusters 631-633 from historical database 801 and/or NPE clusters 631-633. Training module 701 generates training data 802. As illustrated in FIG. 8, training data 802 associates TPS rates for hardware that executes a TPS cluster with time, day of week (DOW), and date. For example, the first data row of training data 802 associates a TPS rate of 532 for cluster A (e.g., cluster 631) with 11:00 PM on Friday, April 19^{th}. These data entries are exemplary and may differ in other examples. While training data 802 is illustrated as having six data rows, model 702 is typically trained using data sets with many more entries (e.g., thousands). Traffic forecasting machine learning model 702 ingests feature vectors that represent training data 802 and processes the feature vectors to produce a training output The training output predicts a past TPS rates for NPE clusters 631-633 at corresponding past times. For example, model 702 may train its algorithms to associate TPS rate increases for NPE cluster 631 between 11: 00PM and 1:00 AM during weekdays. When using unsupervised training, model 702 compares the predicted past TPS rates to the actual past TPS rates to assess the accuracy of the prediction. Model 702 then adjusts its algorithm weights based on the accuracy of the prediction to advance the training state of its algorithms. When using supervised training, operators compare the TPS rate predictions to actual TPS rate values and manually adjust the algorithm weights to advance the training state of model 702. When the training state of model 702 is sufficient (e.g., prediction accuracy exceeds an operator defined threshold), model 702 is pushed to production.

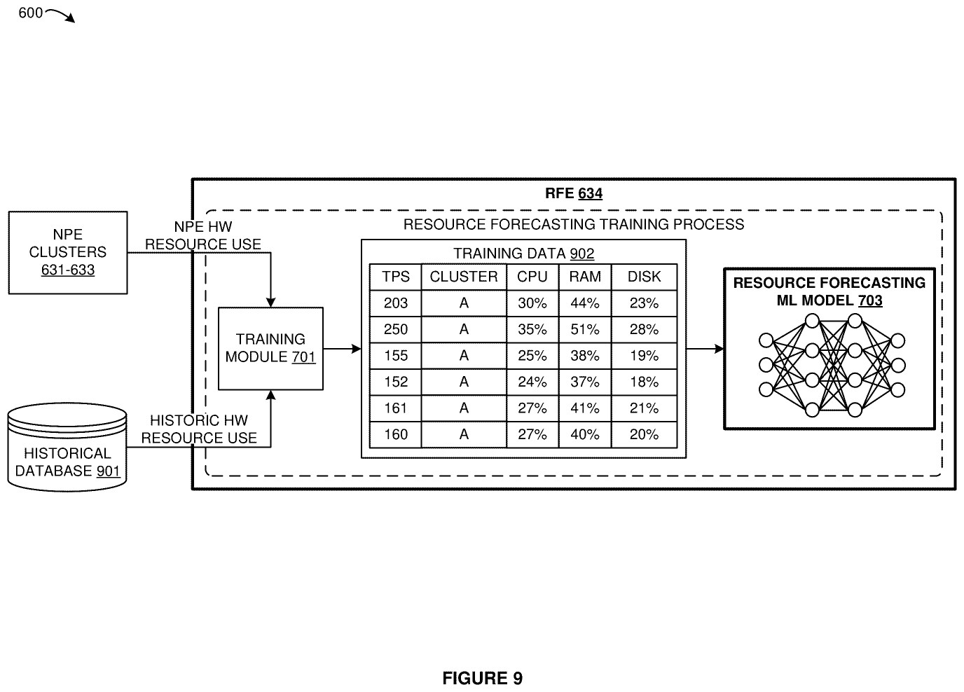

FIG. 9 illustrates an exemplary operation of 5G communication network 600 to train resource forecasting machine learning model 703. In some examples, training module 701 collects historic hardware resource use data for NPE clusters 631-633 from historical database 901 and/or NPE clusters 631-633. Training module 701 generates training data 902. As illustrated in FIG. 9, training data 902 associates TPS rates for hardware that executes an NPE cluster with CPU, RAM, and disk memory allocations for that cluster. For example, the first data row of training data 902 associates a TPS rate of 532 for cluster A with an allocation of 30% of available CPU, 44% of available RAM, and 23% of available disk memory. These data entries are exemplary and may differ in other examples. While training data 902 is illustrated as having six data rows, model 703 is typically trained using data sets with many more entries. Resource forecasting machine learning model 703 ingests feature vectors that represent training data 902 and processes the feature vectors to produce a training output The training output predicts a past hardware resource allocation for NPE clusters 631-633 at corresponding past TPS rates. When using unsupervised training, model 703 compares the predicted past hardware allocations to the actual past hardware allocations to assess the accuracy of the prediction. Model 703 then adjusts its algorithm weights based on the accuracy of the prediction to advance the training state of its constituent algorithms. When using supervised training, operators compare the hardware allocations predictions to the actual hardware allocations and manually adjust the algorithm weights to advance the training state of model 703. When the training state of model 703 is sufficient, model 703 is pushed to production.

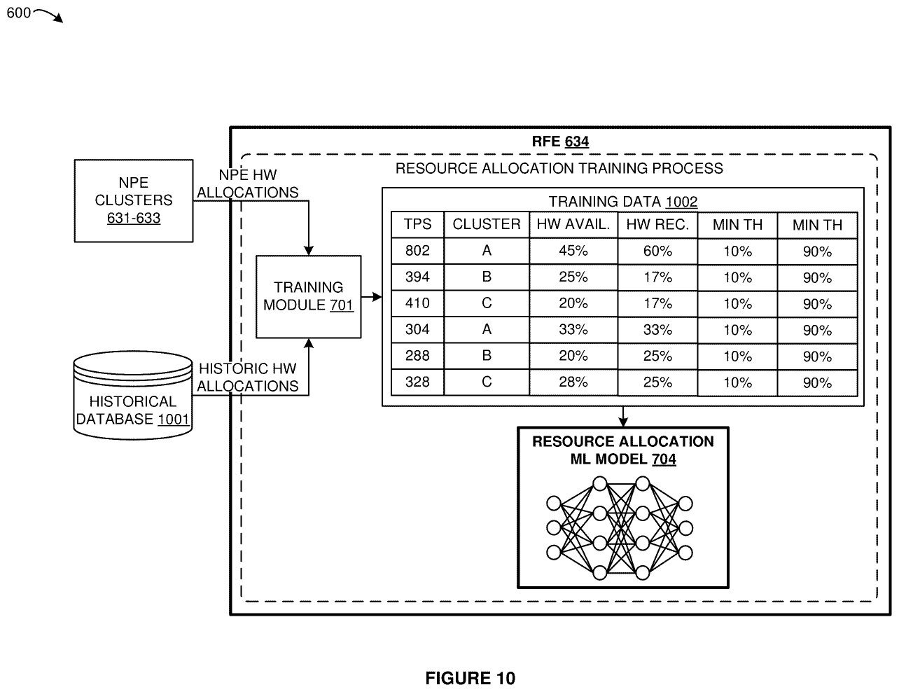

FIG. 10 illustrates an exemplary operation of 5G communication network 600 to train resource allocation machine learning model 704. In some examples, training module 701 collects historic hardware resource allocation data for NPE clusters 631-633 from historical database 1001 and/or NPE clusters 631-633. Training module 701 generates training data 1002. As illustrated in FIG. 10, training data 1002 associates TPS rates for hardware that executes a NPE cluster with hardware availabilities, hardware allocation recommendations, a minimum (MIN) use threshold (TH), and a maximum (MAX) use threshold for that cluster. The hardware availability data relates to CPU, RAM, disk memory, and/or other computing resource availability. The hardware recommendation data relates to CPU, RAM, disk memory, and/or other computing resource recommendations to support the TPS rates. For example, the first data row of training data 1002 associates a TPS rate of 802 for cluster A with a computing resource availability of 45%, a recommended allocation of 60% to cluster A, a minimum threshold of 10% of computing resources, and a maximum threshold of 90% of computing resources. These data entries are exemplary and may differ in other examples. While training data 1002 is illustrated as having six data rows, model 704 is typically trained using data sets with many more entries. Resource allocation machine learning model 704 ingests feature vectors that represent training data 1002 and processes the feature vectors to produce a training output The training output recommends allocations for NPE clusters 631-633 at corresponding past times. When using unsupervised training, model 704 compares the recommended hardware allocations to the actual past hardware allocations to assess the accuracy of the prediction. Model 704 then adjusts its algorithm weights based on the accuracy of the prediction to advance the training state of its constituent algorithms. For example, model 704 may produce a training output that over-allocates the available computing resources for clusters 631-633 and may update its algorithms to inhibit overallocation in future outputs. When using supervised training, operators compare the recommended hardware allocations to the actual hardware allocations and manually adjust the algorithm weights to advance the training state of model 704. When the training state of model 704 is sufficient, model 704 is pushed to production.

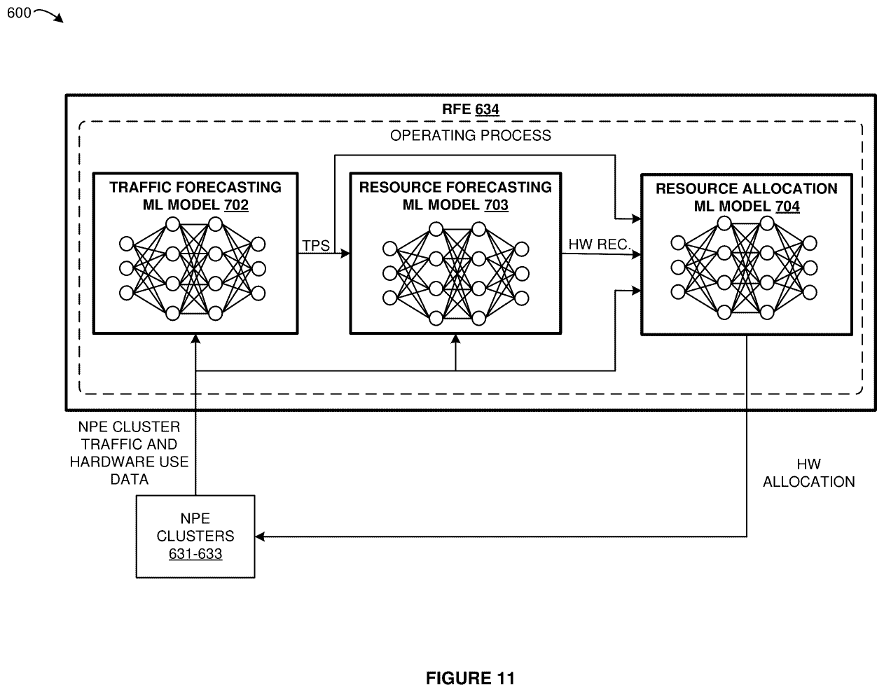

FIG. 11 illustrates an exemplary operation of 5G communication network 600 to allocate computing resources to NPE clusters 631-633 using trained models 702-704. In some examples, NPE clusters 631-633 transfer batch files that comprise NPE cluster traffic (e.g., TPS rates) and hardware use data (e.g., current hardware allocations and maximum hardware use). RFE 634 converts the received data into feature vectors and passes the resulting feature vectors to models 702-704. Traffic forecasting model 702 ingests the feature vectors and produces an output that predicts future TPS rates for clusters 631-633 at a future time based on the current TPS rates and the current time. RFE 634 converts the output into feature vectors representing the predicted TPS rates and passes the resulting feature vectors to resource forecasting model 703 and resource allocation model 704. Resource forecasting model 703 ingests feature vectors representing the predicted TPS rate and the data received from NPE clusters 631-633. Model 703 produces an output that predicts future hardware requirements for each of clusters 631-633 to support the predicted TPS rates. RFE 634 converts the output into feature vectors representing the predicted hardware requirements and passes the resulting feature vectors to resource allocation model 704. Model 704 ingests the feature vectors representing the NPE clusters traffic and hardware use data, the feature vectors representing the predicted TPS rates, and the feature vectors representing the predicted hardware requirements. Model 704 produces an output that allocates portions of the available CPU, RAM, and disk memory to each of clusters 631-633. RFE 634 transfers a resource allocation command to NPE clusters 631-633 allocating the portions of the available CPU, RAM, and disk memory as recommended by model 704.

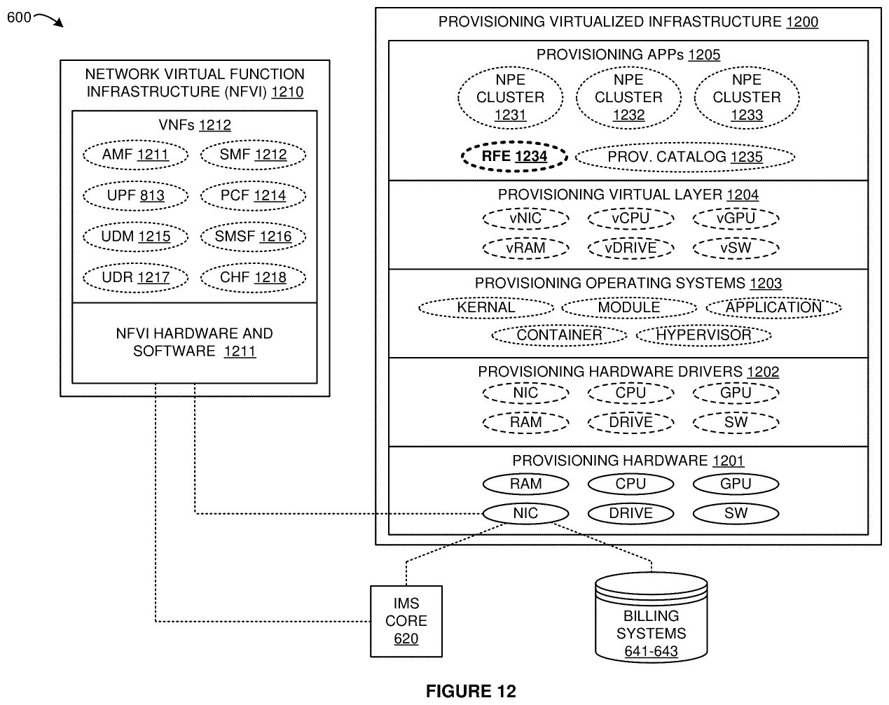

FIG. 12 illustrates provisioning virtualized infrastructure 1200 and Network Function Virtualization Infrastructure (NFVI) 1210 in 5G wireless communication network 600. Provisioning virtualized infrastructure 1200 comprises an example provisioning system 130 illustrated in FIG. 1 and provisioning system 310 illustrated in FIG. 3, however systems 130 and 310 may differ. NFVI 1210 comprises an example of core network 120 illustrated in FIG. 1 and network circuitry 301 illustrated in FIG. 3, however core network 120 and network circuitry 301 may differ.

Provisioning virtualized infrastructure 1200 comprises provisioning hardware 1201, provisioning hardware drivers 1202, provisioning operating systems 1203, provisioning virtual layer 1204, and provisioning applications (APPs) 1205. Provisioning hardware 1201 comprises Network Interface Cards (NICs), CPU, GPU, RAM, Flash/Disk Drives (DRIVE), and Data Switches (SW). Provisioning hardware 1201 forms the pool of available computing resources to form NPE clusters 631-633. Provisioning hardware drivers 1202 comprise software that is resident in the NIC, CPU, GPU, RAM, DRIVE, and SW. Provisioning operating systems 1203 comprise kernels, modules, applications, containers, hypervisors, and the like. Provisioning virtual layer 1204 comprises vNIC, vCPU, vGPU, vRAM, vDRIVE, and vSW. Provisioning applications 1205 comprise NPE clusters 1231-1233, RFE 1234, and provisioning catalog 1235. Additional provisioning applications are typically present but are omitted for clarity. In some examples, provisioning virtualized infrastructure 1200 utilizes a container-based orchestration system like Kubernetes.

NFVI 1210 comprises NFVI hardware and software 1211 and Virtual Network Functions (VNFs) 1212. NFVI hardware and software 1211 comprises NFVI hardware, NFVI hardware drivers, NFVI operating systems, and an NFVI virtual layer. The NFVI hardware comprises NICs, CPU, RAM, flash/disk drives, and data switches. The NFVI hardware drivers comprise software that is resident in the NIC, CPU, RAM, flash/disk drives, and data switches. The NFVI operating systems comprise kernels, modules, applications, containers, hypervisors, and the like. The NFVI virtual layer comprises vNIC, vCPU, vRAM, virtual flash/disk drives, and virtual data switches. VNFs 1212 comprise AMF 1211, SMF 1212, UPF 1213, PCF 1214, UDM 1215, SMSF 1216, UDR 1217, and CHF 1218. Additional VNFs and network elements like AUSF, NSSF, NRF, EIR, NEF, and AF are typically present but are omitted for clarity.

Provisioning virtualized infrastructure 1200 and NFVI 1210 may be located at a single site or be distributed across multiple geographic locations. The NIC in provisioning hardware 1201 is coupled to a NIC in NFVI hardware and software 1211, to IMS core 620, and billing systems 641-643. The NIC in NFVI hardware and software 1211 is coupled to the NIC in provisioning hardware 1201 and to IMS core 620. Provisioning hardware 1201 executes provisioning hardware drivers 1202, provisioning operating systems 1203, provisioning virtual layer 1204, and provisioning applications 1205 using hardware allocations generated by RFE 634 to form NPE clusters 631-633, RFE 634, and provisioning catalog 635. The NFVI hardware in NFVI hardware and software 1211 executes the NFVI hardware drivers, NFVI operating systems, NFVI virtual layer, and VNFs 1212 to form AMF 611, SMF 612, UPF 613, PCF 614, UDM 615, SMSF 616, UDR 617, and CHF 618.

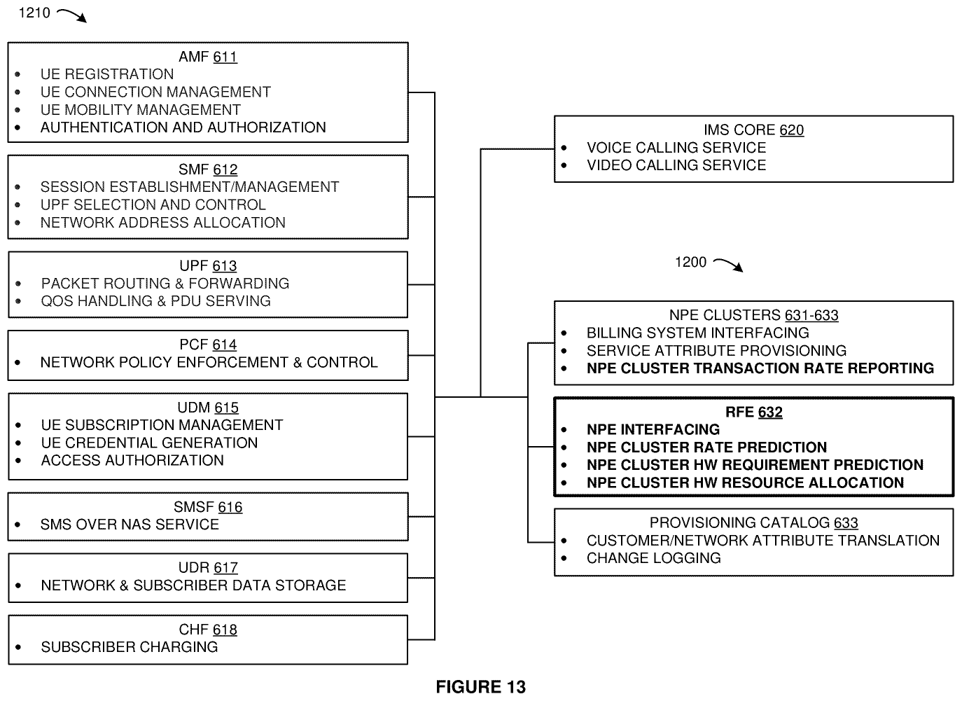

FIG. 13 further illustrates provisioning virtualized infrastructure 1200, NFVI 1210, and IMS core 620 in 5G communication network 600. AMF 611 comprises capabilities for UE registration, UE connection management, UE mobility management, and UE authentication and authorization. SMF 612 comprises capabilities for session establishment and management, UPF selection and control, and network address allocation. UPF 613 comprises capabilities for packet routing and forwarding, QoS handling, and PDU serving. PCF 614 comprises capabilities for network policy enforcement and network policy control. UDM 615 comprises capabilities for UE subscription management, UE credential generation, and UE access authorization. SMSF 616 comprises capabilities for SMS over Non-Access Stratum (NAS) service. UDR 617 comprises capabilities for network and subscriber data storage. CHF 618 comprises capabilities for subscriber charging. IMS core 620 comprises capabilities for voice calling service and video calling service. NPE clusters 631-633 comprises capabilities for billing system interfacing, service attribute provisioning, and NPE cluster transaction rate reporting. RFE 634 comprises capabilities for NPE interfacing, NPE cluster transaction rate prediction, NPE cluster hardware (HW) requirements prediction, and NPE cluster hardware resource allocation. Provisioning catalog 635 comprises capabilities for customer/network attribute translation and change logging.

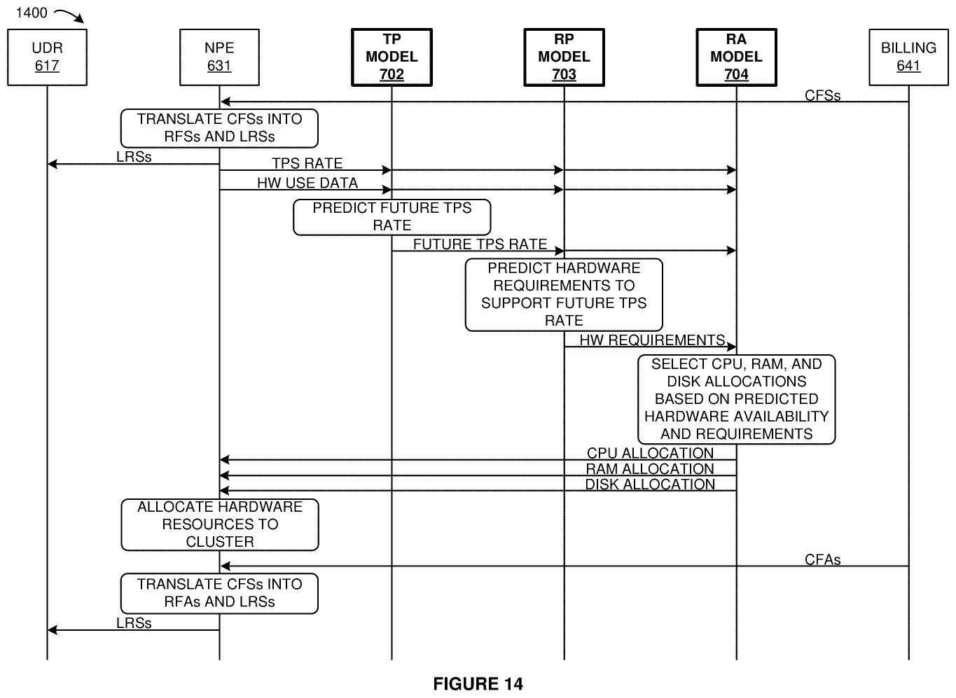

FIG. 14 illustrates an exemplary operation of 5G communication network 600 to allocate resources to network provisioning systems. The operation may vary in other examples. In some examples, billing system 641 receives subscriber requests to modify service on network 600. Billing system 641 generates CFSs that characterize the requests and transfers the CFSs to provisioning system 630. Provisioning system 630 routes the requests to NPE cluster 631 based on cluster 631's association with billing system 641. NPE cluster 631 interfaces with provisioning catalog 635 to translate the CFSs into corresponding RFSs and LRSs. In this example, the RFSs point towards UDR 617. In response, NPE cluster 631 transfers LRSs to UDR 617. UDR 617 writes the LRSs to corresponding subscriber profiles based on subscriber identifiers like IMSI or SUPI. As NPE cluster 631 provisions the LRSs to UDR 617, cluster 631 tracks its TPS rate and maximum CPU, RAM, and disk memory utilizations over a measurement time period. Cluster 631 generates a batch file that comprises the measurements and provides the file to RFE 634.

RFE 634 converts the received data into feature vectors and routes the feature vectors to traffic prediction (TP) model 702, resource prediction model 703, and resource allocation (RA) model 704. Traffic prediction model 702 processes the feature vectors to generate an output predicting the TPS rate for cluster 631 at a future time. RFE 634 converts the output from model 702 into feature vectors representing the predicted TPS rate and passes the feature vectors to models 703 and 704. Resource prediction model 704 processes the feature vectors to generate an output predicting hardware requirements for cluster 631. RFE 634 converts the output from model 703 into feature vectors representing the predicted hardware requirements and passes the feature vectors to resource allocation model 704. Model 704 ingests the feature vectors representing the data received from NPE cluster 631, the predicted TPS rate, and the predicted hardware requirements. Model 704 processes the feature vectors to select CPU, RAM, and disk memory allocations based on the hardware availability, predicted hardware requirements, and hardware use thresholds. RFE 634 indicates the CPU, RAM, and disk memory allocations to NPE cluster. NPE cluster 631 reserves the indicated amounts of CPU, RAM, and disk memory.

Billing system 641 receives additional subscriber requests to modify service on network 600. Billing system 641 generates additional CFSs that characterize the additional requests and transfers the additional CFSs for delivery to NPE cluster 631. NPE cluster 631 executes using its allocated portions of the CPU, RAM, and disk memory. NPE cluster 631 interfaces with provisioning catalog 635 to translate the CFSs into corresponding RFSs and LRSs. NPE cluster 631 transfers LRSs to UDR 617 based on the translated RFSs. UDR 617 writes the LRSs to corresponding subscriber profiles.

The wireless data network circuitry described above comprises computer hardware and software that form special-purpose network circuitry to allocate resources for network provisioning systems. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to allocate resources for network provisioning systems.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
by a resource allocation system in a wireless communication network:
hosting a traffic forecasting machine learning model, a resource forecasting machine learning model, and a resource allocation machine learning model;
obtaining traffic data from a network provisioning engine cluster, wherein the traffic data characterizes a provisioning request rate in the network provisioning engine cluster;
providing the traffic data to the traffic forecasting machine learning model and obtaining a first machine learning output that comprises a future traffic prediction for the network provisioning engine cluster;
providing the future traffic prediction to the resource forecasting machine learning model and obtaining a second machine learning output that comprises a future hardware requirement prediction for network provisioning engine cluster;
providing the future hardware requirement prediction to the resource allocation machine learning model and obtaining a third machine learning output that comprises a hardware allocation recommendation for the network provisioning engine cluster; and
allocating hardware resources to the network provisioning engine cluster based on the hardware allocation recommendation.

2. The method of claim 1 wherein:
providing the traffic data to the traffic forecasting machine learning model comprises generating first feature vectors that represent the traffic data and providing the first feature vectors to the traffic forecasting machine learning model;
providing the future traffic prediction to the resource forecasting machine learning model comprises generating second feature vectors that represent the future traffic prediction and providing the second feature vectors to the resource forecasting machine learning model; and
providing the future hardware requirement prediction to the resource allocation machine learning model comprises generating third feature vectors that represent the future hardware requirement prediction and providing the third feature vectors to the resource allocation machine learning model.

3. The method of claim 1 wherein the traffic data indicates a number of Application Programming Interface (API) requests received by the network provisioning engine cluster over a time period, an API request success rate, an API request failure rate, and a total Transaction Per Second (TPS) rate for the network provisioning engine cluster.

4. The method of claim 1 further comprising the resource allocation system:
training the traffic forecasting machine learning model to predict the future traffic conditions based on first training data that comprises Transaction Per Second (TPS) rates associated with times of day, days of week, and dates;
training the resource forecasting machine learning model to predict the future hardware requirements based on second training data that comprises correlations between TPS rates in the network provisioning engine cluster and hardware requirements to support the TPS rates; and
training the resource allocation machine learning model to allocate the hardware resources based on third training data that comprises Central Processing Units (CPU) availability, Random Access Memory (RAM) availability, disk memory availability, the Transaction Per Second (TPS) rates in the network provisioning engine cluster, a minimum hardware utilization threshold, and a maximum hardware utilization.

5. The method of claim 1 wherein:
providing the traffic data to the traffic forecasting machine learning model comprises providing the traffic data to the traffic forecasting machine learning model to predict a future Transaction Per Second (TPS) rate for the network provisioning engine cluster based on a current TPS rate, current time, current day of week, and current date; and
obtaining the first machine learning output comprises obtaining a TPS rate prediction in the network provisioning engine cluster.

6. The method of claim 1 wherein:
providing the future traffic prediction to the resource forecasting machine learning model comprises providing a predicted Transaction Per Second (TPS) rate generated by the traffic forecasting machine learning model to the resource forecasting machine learning model to predict a future Central Processing Unit (CPU) requirement, a future Random Access Memory (RAM) requirement, and a future disk memory requirement based on the predicted TPS rate; and
obtaining the second machine learning output comprises obtaining a predicted CPU requirement, RAM requirement, and disk memory requirement to support the predicted TPS rate in the network provisioning engine cluster.

7. The method of claim 1 wherein:
providing the future hardware requirement prediction to the resource allocation machine learning model comprises providing a predicted Central Processing Unit (CPU) requirement, Random Access Memory (RAM) requirement, and disk memory requirement generated by the resource forecasting machine learning model to the resource allocation machine learning model to select a CPU allocation, a RAM allocation, and a disk memory allocation for the network provisioning engine cluster based on the predicted CPU, RAM, and disk memory requirements, current CPU, RAM, and disk memory availabilities, current Transaction Per Second (TPS) rate, a minimum hardware utilization threshold, and a maximum hardware utilization; and
obtaining the third machine learning output comprises obtaining the CPU allocation, the RAM allocation, and the disk memory allocation for the network provisioning engine cluster.

8. The method of claim 1 wherein allocating the hardware resources to the network provisioning engine cluster comprises directing a virtualized infrastructure that hosts the network provisioning engine cluster to assign an amount of Central Processing Units (CPUs), Random Access Memory (RAM), and disk memory to the network provisioning engine cluster based on the hardware allocation recommendation.

9. The method of claim 1 wherein the wireless communication network comprises a Third Generation Partnership Project (3GPP) communication network.

10. A wireless communication network comprising:
network provisioning circuitry to:
host a network provisioning engine cluster; and
transfer traffic data that characterizes a provisioning request rate in the network provisioning engine cluster; and
resource allocation circuitry to:
host a traffic forecasting machine learning model, a resource forecasting machine learning model trained, and a resource allocation machine learning model trained;
obtain the traffic data;
provide the traffic data to the traffic forecasting machine learning model and obtain a first machine learning output that comprises a future traffic prediction for the network provisioning engine cluster;
provide the future traffic prediction to the resource forecasting machine learning model and obtain a second machine learning output that comprises a future hardware requirement prediction for the network provisioning engine cluster;
provide the future hardware requirement prediction to the resource allocation machine learning model and obtain a third machine learning output that comprises a hardware allocation recommendation for the network provisioning engine cluster; and
direct the network provisioning circuitry to allocate hardware resources to the network provisioning engine cluster based on the hardware allocation recommendation.

11. The wireless communication network of claim 10 wherein the resource allocation circuitry is to:
generate first feature vectors that represent the traffic data and provide the first feature vectors to the traffic forecasting machine learning model;
generate second feature vectors that represent the future traffic prediction and provide the second feature vectors to the resource forecasting machine learning model; and
generate third feature vectors that represent the future hardware requirement prediction and provide the third feature vectors to the resource allocation machine learning model.

12. The wireless communication network of claim 10 wherein the traffic data indicates a number of Application Programming Interface (API) requests received by the network provisioning engine cluster over a time period, an API request success rate, an API request failure rate, and a total Transaction Per Second (TPS) rate for the network provisioning engine cluster.

13. The wireless communication network of claim 10 wherein the resource allocation circuitry is to:
train the traffic forecasting machine learning model to predict the future traffic conditions based on first training data that comprises Transaction Per Second (TPS) rates associated with times of day, days of week, and dates;
train the resource forecasting machine learning model to predict the future hardware requirements based on second training data that comprises correlations between TPS rates in the network provisioning engine cluster and hardware requirements to support the TPS rates; and
train the resource allocation machine learning model to allocate the hardware resources based on third training data that comprises Central Processing Units (CPU) availability, Random Access Memory (RAM) availability, disk memory availability, the Transaction Per Second (TPS) rates in the network provisioning engine cluster, a minimum hardware utilization threshold, and a maximum hardware utilization.

14. The wireless communication network of claim 10 wherein the resource allocation circuitry is to:
provide the traffic data to the traffic forecasting machine learning model to predict a future Transaction Per Second (TPS) rate for the network provisioning engine cluster based on a current TPS rate, current time, current day of week, and current date; and
obtain a TPS rate prediction in the network provisioning engine cluster from the traffic forecasting machine learning model.

15. The wireless communication network of claim 10 wherein the resource allocation circuitry is to:
provide a predicted Transaction Per Second (TPS) rate generated by the traffic forecasting machine learning model to the resource forecasting machine learning model to predict a future Central Processing Unit (CPU) requirement, a future Random Access Memory (RAM) requirement, and a future disk memory requirement based on the predicted TPS rate; and
obtain a predicted CPU requirement, RAM requirement, and disk memory requirement to support the predicted TPS rate in the network provisioning engine cluster from the resource forecasting machine learning model.

16. The wireless communication network of claim 10 wherein the resource allocation circuitry is to:
provide a predicted Central Processing Unit (CPU) requirement, Random Access Memory (RAM) requirement, and disk memory requirement generated by the resource forecasting machine learning model to the resource allocation machine learning model to select a CPU allocation, a RAM allocation, and a disk memory allocation for the network provisioning engine cluster based on the predicted CPU, RAM, and disk memory requirements, current CPU, RAM, and disk memory availabilities, current Transaction Per Second (TPS) rate, a minimum hardware utilization threshold, and a maximum hardware utilization; and
obtain the CPU allocation, the RAM allocation, and the disk memory allocation for the network provisioning engine cluster from the resource allocation machine learning model.

17. The wireless communication network of claim 10 wherein:
network provisioning circuitry comprises a virtualized infrastructure; and wherein the resource allocation circuitry is to:
direct the virtualized infrastructure to assign an amount of Central Processing Units (CPUs), Random Access Memory (RAM), and disk memory to the network provisioning engine cluster based on the hardware allocation recommendation.

18. The wireless communication network of claim 10 wherein the wireless communication network comprises a Third Generation Partnership Project (3GPP) communication network.

19. One of more non-transitory computer readable storage media having program instructions stored thereon, wherein the program instruction, when executed by a computing system, direct the computing system to perform operations, the operations comprising:
hosting a traffic forecasting machine learning model trained, a resource forecasting machine learning model, and a resource allocation machine learning model trained;
obtaining traffic data from a network provisioning engine cluster, wherein the traffic data characterizes a provisioning request rate in the network provisioning engine cluster;
providing the traffic data to the traffic forecasting machine learning model and obtaining a first machine learning output that comprises a future traffic prediction for the network provisioning engine cluster;
providing the future traffic prediction to the resource forecasting machine learning model and obtaining a second machine learning output that comprises a future hardware requirement prediction for network provisioning engine cluster;
providing the future hardware requirement prediction to the resource allocation machine learning model and obtaining a third machine learning output that comprises a hardware allocation recommendation for the network provisioning engine cluster; and
allocating hardware resources to the network provisioning engine cluster based on the hardware allocation recommendation.

20. The computer readable storage media of claim 15 wherein:
the traffic data comprises a current Transaction Per Second (TPS) rate in the network provisioning engine cluster;
providing the traffic data to the traffic forecasting machine learning model comprises providing the current TPS rate to the traffic forecasting machine learning model to predict a future Transaction Per Second (TPS) rate for the network provisioning engine cluster based on the current TPS rate, current time, current day of week, and current date;
obtaining the first machine learning output comprises obtaining a predicted TPS rate in the network provisioning engine cluster;
providing the future traffic prediction to the resource forecasting machine learning model comprises providing the predicted TPS rate to the resource forecasting machine learning model to predict a future Central Processing Unit (CPU) requirement, a future Random Access Memory (RAM) requirement, and a future disk memory requirement based on the predicted TPS rate;
obtaining the second machine learning output comprises obtaining a predicted CPU requirement, RAM requirement, and disk memory requirement to support the predicted TPS rate;
providing the future hardware requirement prediction to the resource allocation machine learning model comprises providing the predicted CPU, RAM, and disk memory requirements to the resource allocation machine learning model to select a CPU allocation, a RAM allocation, and a disk memory allocation for the network provisioning engine cluster based on the predicted CPU, RAM, and disk memory requirements, current CPU, RAM, and disk memory availabilities, the current TPS rate, a minimum hardware utilization threshold, and a maximum hardware utilization;
obtaining the third machine learning output comprises obtaining the CPU allocation, the RAM allocation, and the disk memory allocation for the network provisioning engine cluster; and
allocating the hardware resources to the network provisioning engine cluster comprises directing the network provisioning engine cluster to utilize the CPU allocation, the RAM allocation, and the disk memory allocation.
